(19) United States
(12) Patent Application Publication
(10) Pub. No.: US 2005/0088418 A1
(43) Pub. Date: Apr. 28, 2005

(54) Pen-based computer interface system

(76) Inventor: Mitchell Van Nguyen, Westminster, CA (US)

Correspondence Address: Roy A. Ekstrand, Esq., Ste 150, 3158 Redhill Ave., Costa Mesa, CA, 92626, US

(21) Appl. No.: 10/696,610

(22) Filed: Oct. 28, 2003

(51) Int. Cl. G09G 5/00; G09G 1/00; G09G 3/28; G09G 5/08; G09G 3/22; G09G 3/36; G06T 11/00

(52) U.S. Cl. 345/173; 345/174; 345/175; 345/179; 345/180; 345/181; 345/182; 345/183; 345/158; 345/90; 345/469

(57) ABSTRACT

A pen-based computer is operative to produce a drawn image upon a touch-sensitive display screen. A stylus or pen is utilized in combination with the pen-based computer or touch input to the display screen. An interface system implemented using software additions to the operating system of the computer processor provides a designated button or dedicated button input to the system which facilitates mode selection by simple actuation or non-actuation. In this manner, the stylus or pen need not be lifted from the display screen to access panning or scroll sub routines during writing, drawing, editing or the like.

### FIELD OF THE INVENTION

This invention relates generally to pen-based computer systems such as personal digital assistants, (PDAs), palm PCs, or pen tablets (collectively hereinafter referred to as “pen-based handheld computers or pen-based computers) and particularly to the use thereof in functions such as writing, drawing or editing.

### BACKGROUND OF THE INVENTION

Pen-based computer systems are well known and extremely popular in the art. The term “pen-based” is derived primarily from the extensive use of a stylus or “pen” to input information or manipulate the operation of a computer using touch screen selection and input. The stylus or pen is not generally a writing instrument but rather an elongated somewhat pointed object which is often housed within the computer unit itself and withdrawn for its interaction and use. Typically, the pen may be used to touch the display screen in order to perform functions of interactions such as selection of a displayed icon, movement of a scroll icon for image displacement or writing and mark up upon a displayed image.

While virtually any computer utilizing a touch screen and interacting stylus for input function may, in a sense, be described as “pen-based”, the term has generally become descriptive in the computer arts of a handheld relatively small computer device which initially was referred to as a personal digital assistant (PDA). A substantial variety of such pen-based computers have been provided in the art by manufacturers such as Palm, Sony, Handspring, ViewSonic, Hewlett-Packard, Casio, Compaq, Toshiba and others. Despite the large number of manufacturers producing pen-based handheld computers and the resulting variety of designs employed by each, all pen-based handheld computers generally include a small relatively flat generally rectangular housing within which a miniaturized computer circuit and memory is housed. A plurality of interactive buttons are usually supported upon the front surface of the housing and a typically rectangular interactive touch screen display is also provided. Additional circuitry within the housing allows the computer processor to interact with and manage the forming of display images upon the display screen and the reading of information applied via screen touching. A so-called pen which is actually a stylus is typically secured or received within a convenient holding position on or within the unit housing. The pen is generally elongated, usually cylindrical, and defines a relatively blunt point for screen touch action.

As low-cost microprocessor based computer and digital circuitry has become available in the market, such pen-based handheld computers have become increasingly popular and pervasive. Not surprisingly, a large number of system improvements and advances have also been provided by various practitioners in the art to move the product capabilities and efficiencies of pen-based computer systems forward to enhance product appeal. For example, U.S. Pat. No. 6,493,464 issued to Hawkins et al. sets forth a MULTIPLE PEN STROKE CHARACTER SET AND HANDWRITING RECOGNITION SYSTEM WITH IMMEDIATE RESPONSE which is capable of interpreting a special predefined set of single stroke glyphs. Each input stroke is identified with one of three categories, (1) pre-character modifier strokes, (2) character or symbol strokes, or (3) post-character modifier strokes. Each character stroke is independently recognized by the system processor and utilized in performing the display interpretation recognition and implementation.

U.S. Pat. No. 6,396,481 issued to Challa et al. sets forth an APPARATUS AND METHOD FOR PORTABLE HANDWRITING CAPTURE which combines a capture device such as a PDA, Notebook Computer, Set Top Box, Smart Television or other type of smart appliance having an image capture capability and built-in wireless transceiver together with an ink capture device. Communication between the ink capture device and the image capture device is achieved with conventional wireless technology.

U.S. Pat. No. 5,615,384 issued to Allard et al. sets forth a PERSONAL COMMUNICATOR HAVING IMPROVED ZOOM AND PAN FUNCTIONS FOR EDITING INFORMATION ON TOUCH-SENSITIVE DISPLAY which includes a casing for housing a cellular telephone, modem, and data processing system. Graphic image files are stored and can be selectively displayed on a touch screen display. A zoom function magnifies areas of a graphic image such as fax image that has been received and stored within the device. The image may be magnified by touching the to-be-magnified area on the screen. A pan function allows the user to shift the image within a viewing area. The user is able to pan the image by touching the display at an initial touch point and moving his/her finger keeping it in contact with the screen to shift the touch point to a new image location. Upon releasing the touch point, the image is redrawn in a new position corresponding to the change in position between initial and final touch points.

U.S. Pat. No. 4,633,436 issued to Flurry sets forth a REAL-TIME RUB-OUT ERASE FOR AN ELECTRONIC HANDWRITING FACILITY which includes a central processing unit, an all points addressable display and an electronic tablet and stylus. The handwriting facility simulates writing with a pen and pencil and paper. An electronic document is generated by periodically sending information to the central processing unit including the absolute location of the stylus in relation to the tablet. Each point is mapped to the display coordinate system and the points are stored in a point list. The handwriting facility is provided with a real-time rub-out erase feature wherein the handwriting facility is first set to erase mode and then the points in the point list to be erased are identified.

J U.S. Pat. No. 6,476,831 issued to Wirth et al. sets forth a VISUAL SCROLLING FEEDBACK AND METHOD OF ACHIEVING THE SAME which provides real-time visual feedback to the user while scrolling in standard windowing environments. The visual scrolling technique makes use of a transient overlay which provides direct visual cues to the user about the new areas of the scrolled document that have been exposed to view by the scrolling action.

U.S. Pat. No. 5,616,089 issued to Miller sets forth a METHOD OF PUTTING which features the golfers dominant hand so that the golfer is able to improve control over the putting speed and direction.

U.S. Pat. No. 6,407,749 issued to Duke sets forth a COMBINED SCROLL AND ZOOM METHOD AND APPARATUS for simultaneously scrolling and zooming graphic data in a display device in response to pointing device action by user. The system alternates between zooming in and zooming out at preset rates in response to successive user actuation of a unique button set on the pointing device. While the button set remains actuated, the pointing device acts to pan the viewpoint.

Despite substantial advances and improvements of current pen-based handheld computer systems, their use in activities such as writing or marking requires further improvement to maximize efficiency. Such systems facilitate writing, drawing or marking the display to form or alter an image by repeatedly sensing the position of the pen point upon the touch screen display to derive a sequential set of pen point touch position. Thereafter, the system displays the locus of the pen point locations as the pen moves and connects each successive pen position in sequence of application to provide an image which is the locus of pen movements in a process similar to a “follow-the-dots” action. As a result, the user sees an image being formed virtually immediately behind the moving pen point upon the screen in a manner which appears to be writing or marking upon the screen by the user.

During such activities of marking, writing, or drawing upon the image screen, a basic limitation arises due to the limited screen size on the small handheld pen-based computer device. In essence, the user in attempting to write or otherwise mark or draw upon the display screen, reaches the end of the display screen and is unable to write to draw further in that limited direction. Current systems address this problem by allowing the user to access a scrolling function which in turn allows the user to move the image in the desired direction upon the screen to free up some additional room. This additional room allows the user to then continue writing or drawing in the previously limited direction.

In a typical pen-based handheld computer device, this scrolling is achieved in the following sequence as the user reaches the end of screen. The user (1) stops writing (2) lifts the pen from the screen (3) uses the pen to touch select a scroll icon (4) moves the pen (and scroll icon) to move and relocate the previously written image. Thereafter, the user (5) lifts the pen and (6) returns the pen to the end of the previous writing action (which has now been scrolled or moved) and finally (7) moves the pen on the display screen to continue writing. Alternatively, as the user reaches the end of screen, the user (1) stops writing (2) lifts the pen from the screen (3) uses the pen to touch select a pan mode (4) lifts the pen (5) uses the pen to touch the screen (6) moves the pen to move and relocate the previously written image. Thereafter, the user (7) lifts the pen from the screen (8) uses the pen to touch select a write mode (9) lifts the pen and (10) returns the pen to the end of the previous writing action (which has now been panned or moved) and finally (11) moves the pen on the display screen to continue writing.

As a result, each time the writing or marking or drawing action of the user causes the pen to move to a screen edge, the above scrolling or panning process is required in order to continue writing etc. in a given direction. Thus, activities such as writing, note-taking, text editing or drawing are relatively inefficient and needlessly time consuming for the user.

There remains therefore a continuing and unresolved need in the art for more efficient and improved interface systems. There further remains a continuing and unresolved need in the art for improved more efficient interface systems for such pen-based computers which reduce the number of pen movements and manipulations required during functions such as writing or the like.

### SUMMARY OF THE INVENTION

It is a general object of the present invention to provide an improved pen-based computer interface system. It is a more particular object of the present invention to provide an improved pen-based computer interface system which reduces the number of pen manipulations and operations required to move or scroll the displayed image upon the display screen. It is a still more particular object of the present invention to provide an improved pen-based computer interface system which allows the user to maintain pen contact with the display screen during operations such as writing or the like and nonetheless be able to move or scroll an image and thereafter continue writing etc.

In accordance with the present invention there is provided an interface system for use in a pen-based handheld computer having a touch-sensitive display screen, at least one input button, a stylus pen and a memory based processor having a stored operating system therein, the interface system comprising: means for causing the processor to operate in a first mode; means for causing the processor to operate in a second mode; means for operating the processor in either the first or second modes; and a button for controlling the means for operating to allow a user to select the first mode or the second mode.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a front view of a typical pen-based handheld computer unit utilizing the present invention improved pen-based computer interface system;

FIG. 2A sets forth an illustrative of a typical writing activity of the type to which the present invention relates;

FIG. 2B sets forth the illustration of FIG. 2A following the utilization of the present invention interface system scroll;

FIG. 3A sets forth a diagram of a typical onscreen window of a pen-based computer system showing the location of an exemplary point of pen contact with the touch-sensitive screen of the computer unit;

FIG. 3B sets forth a diagram of an exemplary virtual or memory housed offscreen window and offscreen touch point location resulting from the onscreen window and onscreen touch point of FIG. 3A;

FIG. 4A sets forth a flow diagram of the operation of the present invention interface system within the system processor;

FIG. 4B sets forth a further flow diagram of the operation of the processor within the present invention interface system;

FIG. 4C sets forth a flow diagram continuing the operation of the processor within the present invention interface system;

FIG. 5 sets forth a front view of a pen-based computer unit employing an alternate embodiment of the present invention interface system.

### DESCRIPTION OF THE PREFERRED EMBODIMENTS OF THE INVENTION

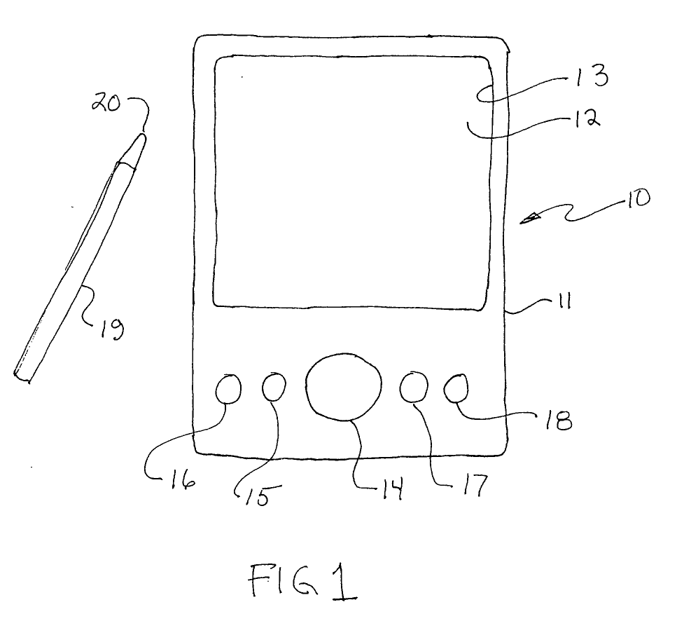

FIG. 1 sets forth a front view of a pen-based computer utilizing the present invention improved pen-based computer interface system generally referenced by numeral 10. It will be apparent to those skilled in the art that the embodiment of the present invention set forth in FIG. 1 may utilize hardware and structure for computer 10 which is fabricated in accordance with conventional fabrication techniques. It will be further apparent to those skilled in the art that the implementation of the present invention set forth in FIG. 1 utilizes software within the processing system of computer 10 (not shown) which employs a previously existing input button to provide the mode selection of the present invention described below. Suffice it to note here that computer 10 is fabricated in accordance with conventional fabrication techniques and includes a generally flat relatively small housing 11 supporting a touch-sensitive display screen 12 having a surrounding edge or border 13. In further accordance with conventional fabrication techniques, pen-based computer 10 includes a plurality of buttons 14, 15, 16, 17 and 18 which are utilized in conventional operation of computer 10. While not seen in FIG. 1, it will be understood that computer 10 further includes internal digital electronic processing circuitry which carries forward the stored programs within computer 10 in accordance with conventional fabrication techniques. Computer 10 is pen-based and thus includes a stylus or pen 19 having a point 20 formed thereon.

By way of overview, the general operation of computer 10 is carried forward in accordance with conventional operation and in accordance with the stored program therein. Such stored programs are well known in the art and need not be described herein. By way of example, computer 10 may utilize a Palm Tungsten T model PDA manufactured by Palm Corporation. In further with conventional fabrication, computer 10 is operated by a stored internal program known as Palm OS. In accordance with the fabrication of computer 10 by Palm Corporation and the utilization of Palm OS operating system, the user is able to select various modes of operation using buttons 14 through 18 and is able to input mode selection and information utilizing contact of point 20 of pen 19 upon touch-sensitive screen 12.

In accordance with the present invention and as is set forth below in greater detail, the implementation of the present invention shown in FIG. 1 utilizes additional software which is added to the operating software within computer 10 to alter the performance and functioning of computer 10 to achieve the advantages of the present invention system. Of particular importance in utilizing the present invention and as is described below in greater detail, the present invention interface is able to alter the assignment of operational significance for a selected one of buttons 14 through 18 to substitute the provision of a button event interpretation which is designated as either a “draw state or no draw state” and a “pan state or no pan state”. By way of overview, it will be noted that FIG. 5 below sets forth an alternate embodiment of the present invention computer interface in which the need to reassign a button function in this manner is removed by substituting a dedicated button or buttons for this mode selection. Suffice it to note here that a selected button within computer 10 is assigned a designation which switches the mode of system operation during the writing activities between the write function and scroll or pan function as desired.

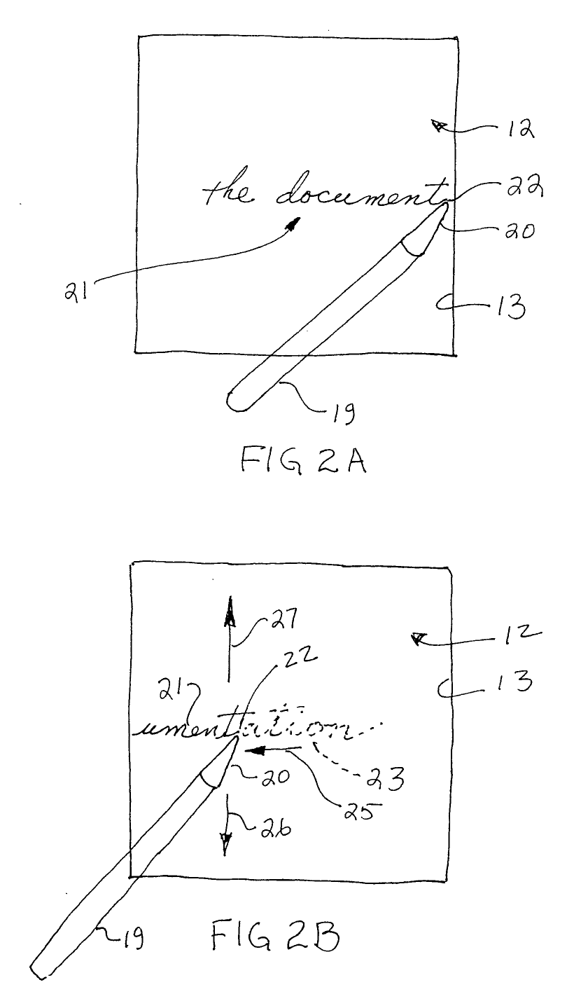

FIG. 2A sets forth an example of the operation of the present invention interface system during a typical writing activity of the type frequently provided by PDAs or other pen-based handheld computer units. FIG. 2A shows a touch-sensitive display screen 12 surrounded by an outer border 13 which, as is shown in FIG. 1, is essentially the physical viewing window edge within housing 111 of computer 10. Thus, the portion of display screen 12 seen surrounded by border 13 is generally referred to as the “onscreen window”. In essence, the onscreen window of display screen 12 defines the region which is capable of visible image display. By way of further example, pen 19 having point 20 is shown in the process of writing the words “the documentation” as part of a typical or illustrative writing function. As illustrated in FIG. 2A however, the image location of image 21 which is viewable or visible upon image screen 12 and which is often referred to as “digital ink” is shown at image end 22 to have reached the right edge of border 13. As a result, the user is unable to continue writing and complete the word “documentation” due to the lack of room to the right on display screen 12.

FIG. 2B illustrates the display screen and writing operation described above in FIG. 2A following the utilization of the present invention interface system to provide additional room to the right and to provide continuation of the writing activity. More specifically, FIG. 2B sets forth touch-sensitive display screen 12 surrounded by a border 13 upon which a stylus or pen 19 having a point 20 is in the process of writing. As described above, pen 19 which will be understood to be held by a user's hand is attempting to write a displayed image 21 which includes the word “documentation”. As is also mentioned above, at an image end point 22, pen 19 required additional room to the right of the edge of border 13 to continue writing and complete the word “documentation”.

In accordance with the present invention and is described below in greater detail, the user is able to transition from the edge limited situation of FIG. 2A to the moved image situation of FIG. 2B without lifting point 20 of pen 19 from touch-sensitive display screen 12. While this operation is described below in greater detail, suffice it to note here that this operation is carried forward by the user in a simple and very natural manner. More specifically, the user having reached the edge of border 13 as shown in FIG. 2A simply actuates a selected one of buttons 14 through 18 to transfer the operation of the operating system within computer 10 from the write mode to the pan mode. Once the mode switch button has been activated, the user then simply moves point 20 of pen 19 away from the right edge of border 13 in the direction indicated by arrow 25. In accordance with the system operation set forth below in greater detail, image end 22 and image 21 is then panned or scrolled to the left in the direction indicated by arrow 25 providing additional writing space for the user. Thereafter, the user releases the mode select dedicated button and the operating system within computer 10 returns to the write mode and the user then is able to continue writing in a normal fashion as indicated by dashed line complete image portion 23 in a natural writing activity. Thus, in accordance with the present invention, the user is able to move the written image upon display screen 12 as required without lifting point 20 of pen 19 from the touch screen by simply activating the designated mode select button. It will be apparent to those skilled in the art that while the example shown in FIGS. 2A and 2B of the present invention interface system operation is illustrated by a movement of image 21 to the left as indicated by arrow 25, the system is equally capable of moving the image to the right in the opposite direction of arrow 25 or alternatively, upwardly in the direction of arrow 27 or downwardly in the direction indicated by arrow 26.

In accordance with the operation of the present invention system illustrated in FIGS. 2A and 2B, the present invention interface system described below in greater detail is able to utilize a preexisting button upon computer 10 to provide easy switching between operational modes and thereby facilitate the more efficient writing operation illustrated in FIGS. 2A and 2B. It will be apparent to those skilled in the art that while the movement of pen 19 to perform writing activities as an example in FIGS. 2A and 2B, the present invention system functions in an equally advantageous manner for operations of a similar nature such as drawing, editing, or otherwise marking up a displayed image. The simple selection of mode by a button is made by the user's non-writing hand in a two-handed operation to provide further efficiency. This two-handed operation of the host computer utilizing the present invention interface system substantially improves efficiency in that the users writing hand does not need to be lifted from the writing position while a separate menu access or scrolling icon is selected and operated by the pen point. Instead, a second hand operation of the mode select button allows the user to continue the writing operation in a very natural and efficient manner without disturbing concentration or information flow. As a result, the user simply writes across touch-sensitive screen 12 until a border is approached or encountered, activates the mode select button while maintaining pen point position, moves the pen point and thereby the image in the desired direction, and releases the mode select button to continue writing in a very natural sequence of movements. It has been found that a typical user adjusts very quickly to this improved and more efficient operation and maintains a much greater productivity in utilizing the host computer when the present invention computer interface system is installed.

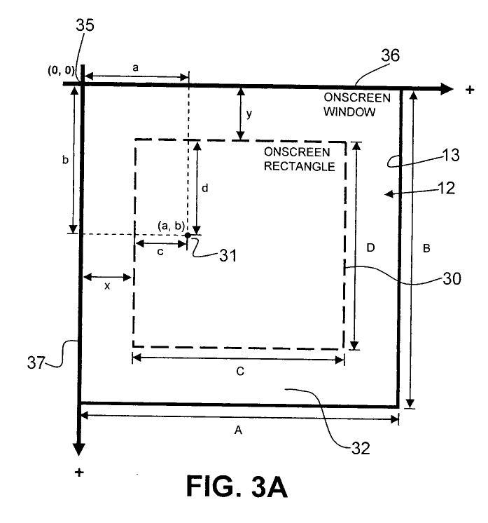

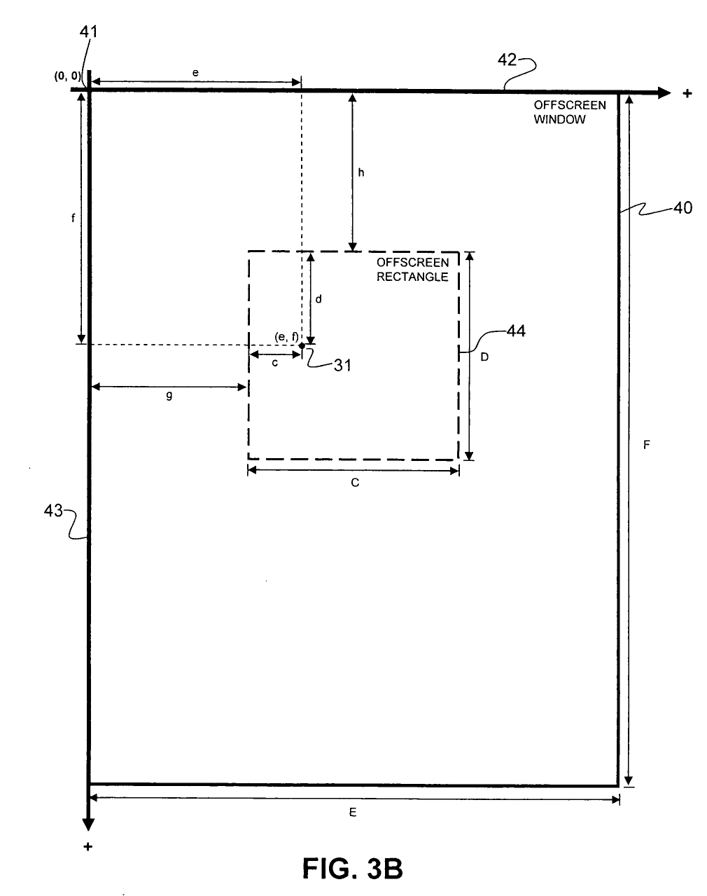

FIG. 3A sets forth an illustrative diagram of an onscreen display window and display rectangle of the type which corresponds to touch-sensitive display screen 12 of computer 10 and as is utilized in illustration in FIGS. 2A and 2B. For purposes of illustration in FIG. 3A, the locating process for defining the location of a single pen point touch is utilized. It will be apparent to those skilled in the art, that the operation of the present invention system which will be illustrated in FIGS. 3A and 3B for this single sample point is applicable to each successive point location as the pen in contact with touch-sensitive display screen 12 (seen in FIG. 1) is moved in the above described writing activity or other similar drawing or writing actions. This results from the operation of the processor within computer 10 on a repetitive looped basis to form a continuous image as the pen writes upon the touch-sensitive display screen.

More specifically, FIG. 3A sets forth a diagram of touch-sensitive display screen 12 which defines an onscreen window corresponding to the area within surrounding border 13. For purposes of assigning a location to each point within onscreen window 12 at which the user may touch the pen point, an origin 35 is established together with an X axis 36 which extends substantially horizontally and a Y axis 37 which extends substantially vertically. Thus, the maximum X axis coordinate for any point within onscreen window 12 is defined as A while the maximum Y axis coordinate for any point upon onscreen window 12 is defined as B, each point within onscreen window 12 is uniquely located by coordinates a, b. The area of onscreen window 12 is further separated into an onscreen rectangle 30 having outer dimensions C and D which is selected to provide an outer area 32 upon onscreen window 12 which may be utilized for display of icons or other information as desired. If the display of surrounding icons or other image elements within an outer area is not required, the borders of onscreen rectangle 30 may be substantially coincident with borders 13 of onscreen window 12. In the illustration shown in FIG. 3A, the onscreen rectangle is distanced from X axis 36 by a distance y and from Y-axis 37 by a distance x.

Thus, in accordance with the utilization of onscreen rectangle 30 within onscreen window 12, an exemplary point location 31 is uniquely located by coordinates a, b and is further located within onscreen window 12 by distances a and b as shown. Alternatively, point 31 may be uniquely located by a second set of coordinate distances c and d referenced to the borders of onscreen rectangle 30. Of importance to note with respect to the present invention is the ability of the system to define each point of pen contact with display screen 12 by a single coordinate set which may then be converted in the manner described below in FIG. 3B to provide effective panning and scrolling and writing. Thus, each time the user touches pen 19 upon touch-sensitive display screen 12 within the onscreen window, a point is uniquely defined and assigned coordinates relative to the onscreen window and onscreen rectangle. In addition, each time the system determines movement of the pen upon touch-sensitive display screen 12 to a new location, a further set of point location coordinates is defined. As mentioned above, successive points of contact as pen 19 is moved is utilized by the processor within computer 10 to “follow the dots” and write upon display screen 12 in a process which is often referred to as “digital ink”.

FIG. 3B sets forth a further diagram of the present invention interface system operation in which an offscreen window corresponding to the virtual memory within the computer processor system is shown which is generally referenced by numeral 40. Offscreen window 40 is a virtual window and is not a window which is entirely viewable in the manner of onscreen 30 described above. Rather, offscreen window 40 is defined by the memory within the processor system. To avoid confusion, window 40 is referred to as offscreen to distinguish it from the onscreen display window provided by display 12. In accordance with the present invention operation described below, offscreen window 40 defines an origin 41 and an X-axis 42 together with a Y-axis 43. The maximum coordinate positions available within offscreen 40 are defined by distances E and F for x and y coordinates respectively.

Within offscreen window 40, an offscreen rectangle 44 is designated having sample point 31 positioned therein. It will be noted that offscreen rectangle 44 is identical in size and dimension to onscreen rectangle 30 but is located within offscreen window 40 by distances g and h. As shown above in FIG. 3A, a sample point or location 31 is shown positioned within offscreen rectangle 44. However, offscreen rectangle 44 and the coordinates of sample point 31 are different from a, b set forth above for onscreen window 12. On the contrary, sample point 31 shows coordinates e, f which are related to origin 41 and offscreen window 40.

Thus, in accordance with the preferred operation of the present invention system, each point such as sample point 31 which is initially located within onscreen window 12 as described above in FIG. 3A must be converted to a second set of coordinates relative to the origin and axes of offscreen window 40. This conversion facilitates the panning and scrolling and writing operation described below which the present invention interface performs. Suffice it note here that having established the allocated memory and virtual offscreen window 40 within the system memory, the present invention system is then able to position offscreen rectangle 44 therein and further to provide a converted relative set of coordinates for each point within onscreen window 12 shown in FIG. 3A. The function of this conversion is to facilitate the movement of offscreen rectangle 44 in either direction within offscreen window 40 during panning, drawing or scrolling operations.

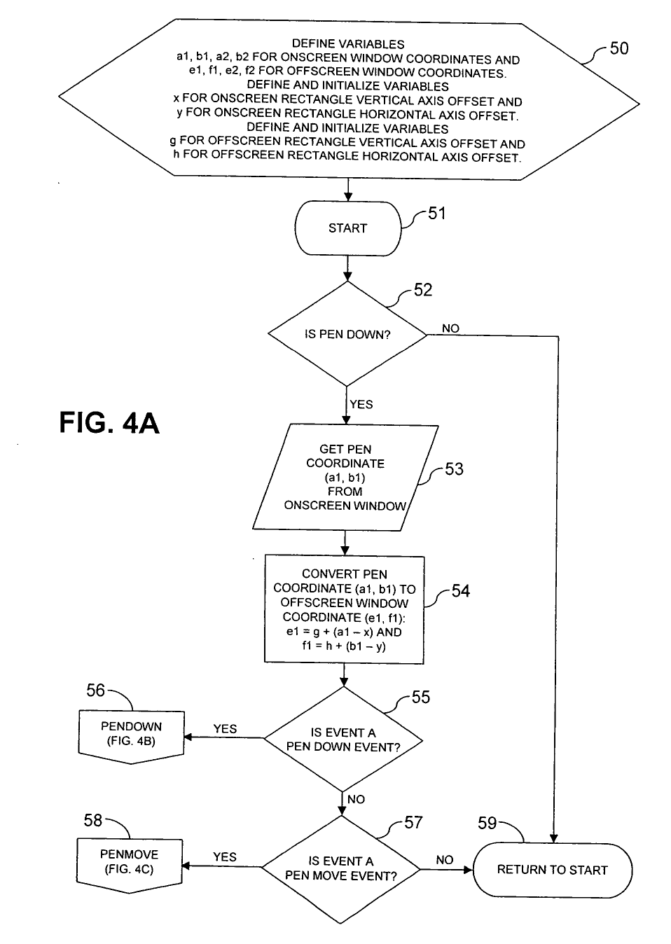

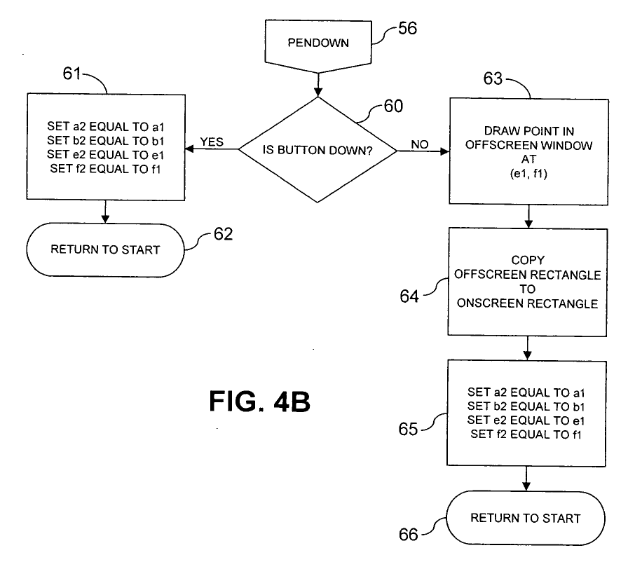

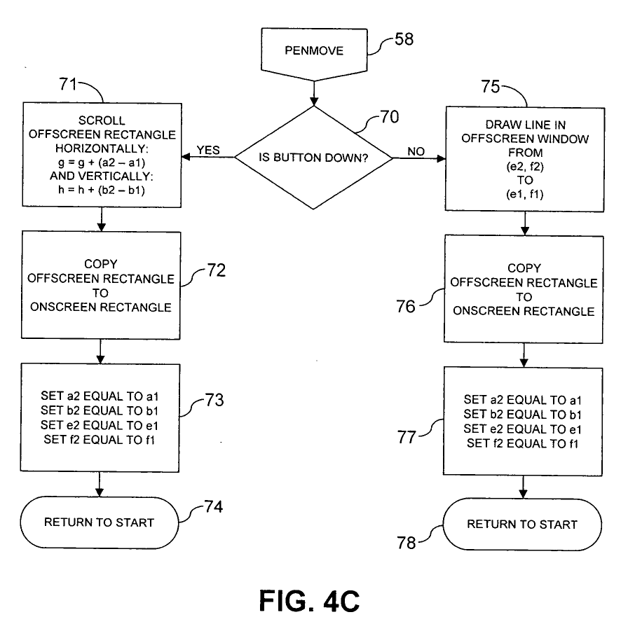

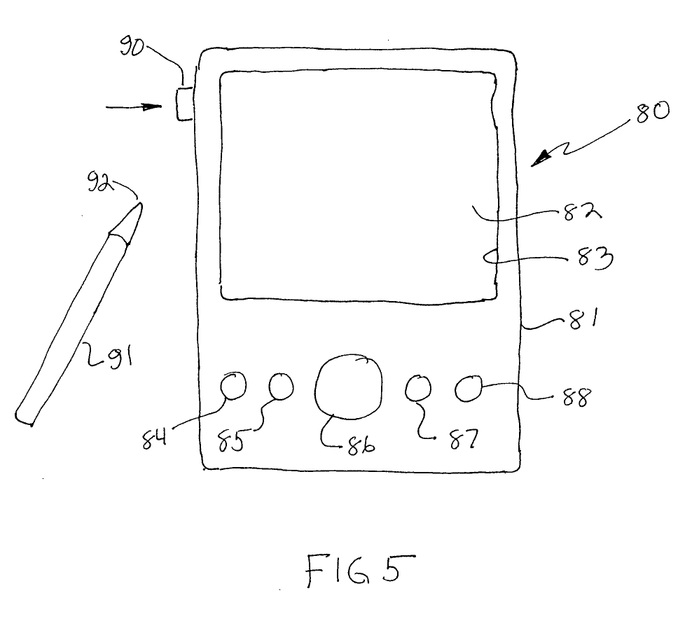

FIGS. 4A, 4B and 4C set forth flow diagrams which show the operation of the present invention computer interface system within the operating system of computer 10 (set forth in FIG. 1). Thus, FIGS. 4A, 4B and 4C taken together describe the operative flow of the software within the host processor of computer 10 which implements the present invention interface system. In the preferred fabrication of the present invention, the operative system utilized in computer 10 is established in accordance with the operating tools provided by the host operating system within computer 10. In the above-mentioned example of a Palm Tungsten T pen-based computer utilizing a Palm OS operating system, these tools are provided as operative functions of the system within the Palm OS operative system. It will be recognized by those skilled in the art that the present invention system may be similarly but perhaps differently implemented within other host systems of other host computers as desired.

More specifically, FIG. 4A sets forth a flow diagram of the present invention system which provides initial activity, coordinate conversion, and sensing of pen down and pen move events. Thus, the system initially at a step 50 defines variables a1, b1, a2, b2 for onscreen window coordinates and e1, f1, e2, f2 for offscreen window coordinates, defines and initializes x, y, g, and h. These coordinates are amply described in FIGS. 3A and 3B above. Of importance to note is the variable definition is provided for each point within the display. Thereafter, at step 51 the program starts its operation and at step 52 determines whether a pen down that is a pen touching of the touch-sensitive screen has occurred. In the event no pen touching has occurred, the system moves to step 59 and returns to start step 51. If however a pen down or touching is found at step 52, the system moves to step 53 and in accordance with FIG. 3A, the system obtains the a1, b1 coordinates for the pen down position or contact point from the onscreen window. Thereafter, at step 54 the system converts the coordinates of the pen down or pen touching position point to coordinates within the offscreen window coordinate system e1, f1. This coordinate system is the system described in FIG. 3B. It will be recalled that each e and f coordinate may be uniquely calculated from the relationships between the onscreen and offscreen coordinate systems.

Following the conversion of coordinates at step 54, the system moves to a step 55 at which it is determined whether the pen down event is the first pen down touch. If the event is a first pen down touch, the system moves to a step 56 and continues processing as shown in FIG. 4B. If however the event is not a first pen down event or touch at step 55, the system moves to step 57 at which it determines whether the event is a pen move event. If at step 57 no pen move event is detected, the system moves to step 59 and returns to start step 51. If however a pen move event is detected, the system moves to step 58 and carries forward the processing set forth in FIG. 4C. Thus, in FIG. 4A, the operation of the present invention system by which each coordinate initially defined within onscreen window 12 is converted to an offscreen coordinate set which may be utilized within the extended or virtual offscreen window 40 and more particularly offscreen rectangle 44 shown in FIG. 3B.

FIG. 4B sets forth a flow diagram of the system operation in response to a pen down event at step 56. Following step 56, the system moves to a step 60 in which a determination is made as to whether the designated mode select button has been pressed. In the event the mode select button has been pressed, the system moves from step 60 to step 61 in which the system maintains the information related to the most recent or last previous point at which the pen down event occurred. This operation is described by the setting of the most recent coordinates in each system to the last previous coordinates in each system. Following the setting of most recent or last previous coordinates in both systems, the operation returns at step 62 to start step 51 shown in FIG. 4A.

In the event a determination is made at step 60 that the mode select button is not pressed, the system moves to a step 63 which provides for the drawing of the most recent point location at coordinates within the offscreen window. Thereafter, the system moves to step 64 in which the offscreen rectangle is copied to the onscreen rectangle. Thereafter, at step 65 the coordinates for the most recent or last previous location are again set and equalized in the same manner as set forth in step 61. Following the equalization of coordinates at step 65, the system moves to step 66 after which it returns to start step 51 shown in FIG. 4A.

Thus, the portion of system operation shown in FIG. 4B provides for the maintenance of most recent position information in each operation or each operational mode regardless of whether the mode select button has been activated or not. It will be recalled, that step 56 is initially entered in response to a pen down event determination at step 55 in FIG. 4A. Thus, the process shown in FIG. 4B results entirely from the occurrence of pen point contact somewhere upon onscreen window 12 (seen in FIG. 3A).

Returning temporarily to FIG. 4A, it will be recalled that in the event a pen down or first pen contact is not detected at step 55, the system moves to step 57 and detects pen movement. Further it will be recalled that in response to a pen movement determination, the system moves to step 58 which returning to FIG. 4C is shown. Thus, FIG. 4C shows the operation of the present invention system in response to pen movement (such as writing or drawing) as opposed to pen contact initially in a pen down event.

More specifically, at step 58 responding to a pen move event, the system moves to step 70 in which a determination is made as to whether the mode select button has been activated or pressed. In the event the mode select button has been pressed, the system moves to step 71 in which the appropriate horizontal and vertical and offscreen rectangle scroll is implemented. This offscreen rectangle scroll corresponds to the difference between the previous and most recent position coordinates determined by the system. Thereafter, at step 72 the system copies the offscreen rectangle to the onscreen rectangle. This provides actual visible scrolling action upon display screen 12 of computer 10. Thereafter, at step 73 the system again updates the last previous point coordinates in the manner described above. Finally, after updating coordinates, the system moves to step 74 and returns to start step 51 shown in FIG. 4A.

If however at step 70 a determination is made that the mode select has not been pressed or activated, the system interprets the users desire to draw as opposed to scroll the image and at a step 75, the system draws a line in the offscreen window from the previous coordinate point to the new coordinate point produced by pen movement. Thereafter, the system moves to step 76 at which the offscreen rectangle is copied to the onscreen rectangle. Once again, this is the process which provides actual visible digital ink drawing upon the display screen. Following step 76, the system moves to step 77 in which the last previous coordinates are again tracked and maintained after which at step 78 the system returns to start step 51 shown in FIG. 4A.

By way of overview, the system operation shown in FIG. 4C results from a determination that a pen movement has occurred. By further overview, the system either proceeds through steps 71 through 74 in response to activation of the mode select button to provide scrolling operation upon the displayed image or alternatively to provide a drawing operation upon the displayed image in response to pen movement in the absence of a mode select button activation as the system proceeds through steps 75 through 78. In this manner it will be dramatically apparent that the present invention system is able to provide continuous writing or drawing action with intermittent scrolling or panning to move the written or drawn image upon the visible display screen by simply activating the mode select button. It will be understood by those skilled in the art that any of the buttons available upon computer 10 such as those shown above in FIG. 1 are useable in the present invention system for designation as a mode select button. In essence, this designation process simply requires sensing the button event produced by the host operating system and intervening to prevent the system response and to convert the button actuation to do mode selection.

FIG. 5 sets forth a front view of an alternate embodiment of the present invention computer interface system generally referenced by numeral 80. Computer 80 is substantially identical to pen-based computer 10 shown in FIG. 1 with the significant difference being found in the use of a dedicated mode select button 90 supported upon the computer housing. Dedicated button 90 is utilized in place of the above-described designation of a selected button all ready found upon host computer 10 as the mode select button. Thus, the pressing or release of button 90 implements the above-described mode selection which occurs in response to the designated button upon computer 10. In all other respects, the operation of computer 80 utilizes the present invention interface system described above and is thus identical thereto. Button 90 may, for example, be a simple momentary contract button which remains open in its relaxed state and which maintains contact when pressed. It will be apparent to those skilled in the art that a variety of different button configurations may be utilized for button 90 such as toggle switches or the like without departing from the spirit and scope of the present invention.

More specifically, computer 80 includes a generally flat housing 81 having a touch-sensitive display screen 82 supported thereon. A border 83 formed in housing 81 surrounds the visible portion of display screen 82. A plurality of user input buttons 84 through 88 are also supported upon housing 81. A pen or stylus 91 is provided for use with pen-based computer 80 in the manner described above. It has been found that the use of a dedicated button which is provided by the manufacture of computer 80 will substantially improve the convenience and use of the present invention interface system. However, apart from this aspect, computers 10 and 80 each provide illustrations of effective use of the present invention pen-based computer interface system which facilitate the use of second hand to provide mode selection and allow continuous pen contact with the touch-sensitive screen. It will be apparent to those skilled in the art that the reverse button response may be used without departing from the spirit and scope of the present invention.

The Appendix attached hereto sets forth an exemplary source code Example_Rsc.h, Example.h, and Example.c which may be used in conjunction with development tools which may include CodeWarrior Development Studio for Palm OS Version 9.1, PilRC Designer for Palm OS Version 2.0.6, and Palm OS SDK 5.0 to generate object code which may further be installed into a Palm Tungsten T device to carry forward the present invention. Those skilled in the art will understand that modifications can be made without departing from the spirit and scope of the present invention. It will be equally apparent to those skilled in the art that while the exemplary source code is shown written in C language, other languages may be used in carrying forward the present invention.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

1. An interface system for use in a pen-based computer having a touch-sensitive display screen, at least one input button, a stylus pen and a memory based processor having a stored operating system therein, said interface system comprising:
means for causing said processor to operate in a first mode;
means for causing said processor to operate in a second mode;
means for operating said processor in either said first or second modes; and
a button for controlling said means for operating to allow a user to select said first mode or said second mode.

2. The interface system set forth in claim 1 wherein said first mode is a write mode and said second mode is a pan mode.

3. The interface system set forth in claim 2 wherein said button is a normally open momentary contact switch.

4. The interface system set forth in claim 3 wherein said write mode is selected when said button is open and said pan mode is selected when said button is pressed and closed.

5. An interface system for use in a pen-based computer having a touch-sensitive display screen and stylus pen together with a processor for writing upon said display screen as said pen is moved upon said display screen and for panning a screen image in response to pen movement of said pen upon said display screen, said interface system comprising:
a button for user selection between operations of writing or panning;
means for causing said processor to implement writing in response to said button being non activated; and
means for causing said processor to implement panning in response to said button being activated.

6. The interface system set forth in claim 3 wherein said pan mode is selected when said button is open and said write mode is selected when said button is pressed and closed.

7. The interface system set forth in claim 2 wherein said button is a normally closed momentary contact switch.

8. An interface system for use in a pen-based computer having a touch-sensitive display screen and stylus pen together with a processor for writing upon said display screen as said pen is moved upon said display screen and for panning a screen image in response to pen movement of said pen upon said display screen, said interface system comprising:
a button for user selection between operations of writing or panning;
means for causing said processor to implement writing in response to said button being activated; and
means for causing said processor to implement panning in response to said button being non activated.

9. The interface system set forth in claim 7 wherein said write mode is selected when said button is open and said pan mode is selected when said button is pressed and opened.

10. The interface system set forth in claim 7 wherein said pan mode is selected when said button is open and said write mode is selected when said button is pressed and opened.
